(19) United States
(12) Patent Application Publication
(10) Pub. No.: US 2021/0303707 A1
(43) Pub. Date: Sep. 30, 2021

(54) AUTHENTICATION CONTROL SYSTEM, DATA ASSOCIATION SYSTEM, AND SYSTEM

(71) Applicant: KYOCERA Document Solutions Inc., Osaka-shi (JP)

(72) Inventor: Koki NAKAJIMA, Osaka-shi (JP)

(21) Appl. No.: 17/205,428

(22) Filed: Mar. 18, 2021

(30) Foreign Application Priority Data
Mar. 25, 2020 (JP) 2020-055181

(51) Int. Cl. G06F 21/60; G06F 21/33

(52) U.S. Cl. CPC G06F 21/604; G06F 21/33; G06F 21/602

(57) ABSTRACT

A data association system that collects and stores data maintained by an information system issues an authentication token for the data association system by authentication of a user. When the data association system issues an authentication token for the data association system, an authentication proxy that controls authentication of the user in the data association system acquires, from the information system, an authentication token for the information system by using specific authentication information.

### INCORPORATION BY REFERENCE

This application is based upon, and claims the benefit of priority from, corresponding Japanese Patent Application No. 2020-055181 filed in the Japan Patent Office on Mar. 25, 2020, the entire contents of which are incorporated herein by reference.

### BACKGROUND

### Field of the Invention

The present disclosure relates to an authentication control system, a data association system, and a system that achieve a single sign-on between an information system, and a data association system that collects and stores data maintained by the information system.

### Description of Related Art

Typically, there is known an account information association system that achieves a single sign-on between a first system and a second system by providing the first system that authenticates a user with use of account information of the user and issues an authentication token, based on the account information, and the second system that acquires the account information of the user from the authentication token issued by the first system and authenticates the user with use of the account information.

### SUMMARY

An authentication control system according to the present disclosure is directed to an authentication control system for controlling authentication of a user in a data association system that collects and stores data maintained by an information system. The data association system issues an authentication token for the data association system by authentication of a user. The authentication control system acquires, from the information system, an authentication token for the information system by using specific authentication information when the data association system issues an authentication token for the data association system.

A data association system according to the present disclosure is directed to a data association system that collects and stores data maintained by an information system. The data association system includes an authentication control system for controlling authentication of a user. The data association system issues an authentication token for the data association system by authentication of a user. The authentication control system acquires, from the information system, an authentication token for the information system by using specific authentication information when the data association system issues an authentication token for the data association system. The data association system causes use of the data association system when use of the data association system is requested by using an authentication token for the data association system. The data association system makes a request to information system for use of the information system by using an authentication token for the information system, which is acquired when an authentication token for the data association system is issued when use of the information system is requested by using the authentication token for the data association system.

An authentication control system according to the present disclosure is directed to an authentication control system for controlling authentication of a user in a system provided with an information system, and a data association system that collects and stores data maintained by the information system. The information system issues an authentication token for the information system by authentication of a user. The authentication control system acquires, from the data association system, an authentication token for the data association system by using specific authentication information when the information system issues an authentication token for the information system.

A system according to the present disclosure is directed to a system including: an information system; and a data association system that collects and stores data maintained by the information system. The system includes an authentication control system for controlling authentication of a user. The information system issues an authentication token for the information system by authentication of a user. The authentication control system acquires, from the data association system, an authentication token for the data association system by using specific authentication information when the information system issues an authentication token for the information system. The information system causes the information system to use the information system when use of the information system is requested, by using an authentication token for the information system. The information system makes a request to the data association system for use of the data association system by using an authentication token for the data association system, which is acquired when an authentication token for the information system is issued, when use of the information system is requested, by using the authentication token for the information system.

### BRIEF DESCRIPTION OF THE DRAWINGS

FIG. 1 is a block diagram of a system according to a first embodiment of the present disclosure;

FIG. 2 is a sequence diagram of an operation of the system shown in FIG. 1 when a user logs in to a data association system;

FIG. 3 is a sequence diagram of an operation of the system shown in FIG. 1 when the user uses an application service of the data association system;

FIG. 4 is a sequence diagram of an operation of the system shown in FIG. 1 when the user uses an information system;

FIG. 5 is a block diagram of a system according to a second embodiment of the present disclosure;

FIG. 6 is a sequence diagram of an operation of the system shown in FIG. 5 when the user logs in to an information system;

FIG. 7 is a sequence diagram of the operation of the system shown in FIG. 5 when the user uses the information system; and

FIG. 8 is a sequence diagram of an operation of the system shown in FIG. 5 when the user uses an API platform of a data association system.

### DETAILED DESCRIPTION

In the following, embodiments of the present disclosure will be described with reference to the accompanying drawings.

### First Embodiment

First, a configuration of a system according to a first embodiment of the present disclosure is described.

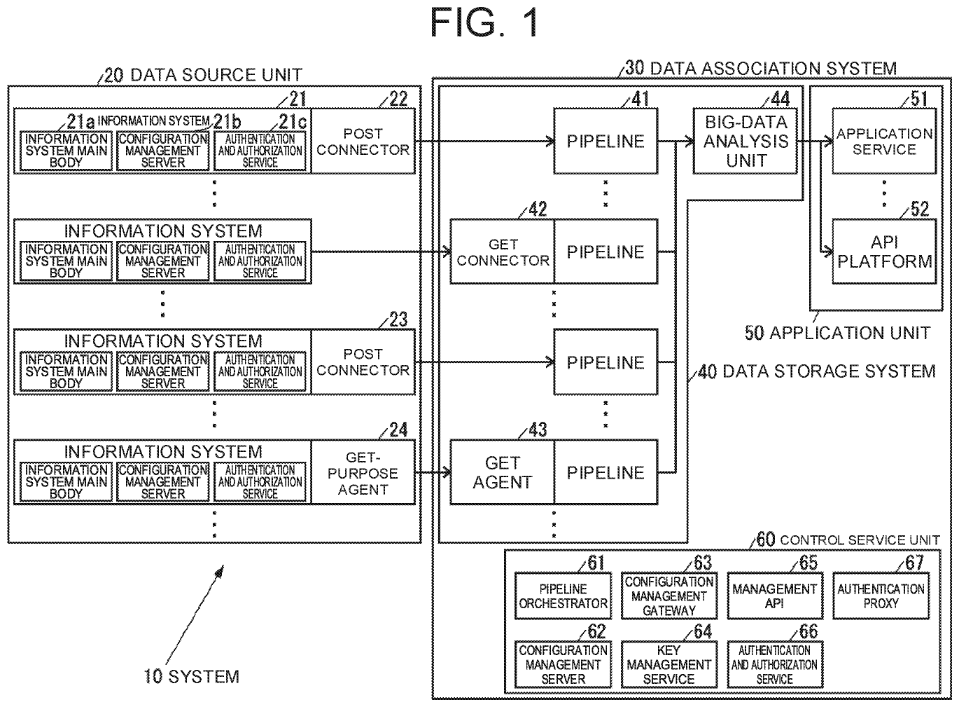

FIG. 1 is a block diagram of a system 10 according to the present embodiment.

As illustrated in FIG. 1, the system 10 includes a data source unit 20 which produces data, and a data association system 30 which associates the data produced by the data source unit 20.

The data source unit 20 is provided with an information system 21 for generating data. The information system 21 includes an information system main body 21a, which is a main body of the information system 21, a configuration management server 21b for storing a configuration and settings of the information system 21, and an authentication and authorization service 21c for performing authentication and authorization of the information system 21. The data source unit 20 may include at least one information system in addition to the information system 21. Examples of information system include an IoT (Internet of Things) system such as a remote management system for remotely managing an image forming apparatus such as a multifunction peripheral (MP) device and a printer-dedicated machine, and an in-house system such as an enterprise resource planning (ERP) system and a production management system. Each of the information systems may be configured by one computer or may be configured by a plurality of computers. The information system may maintain a structured data file. The information system may maintain an unstructured data file. The information system may maintain a database of structured data.

The data source unit 20 includes a POST connector 22, which serves as a data collection system, for acquiring a file of structured data or unstructured data that is maintained in the information system, and transmitting the acquired file to a pipeline, which will be described later, of the data association system 30. The data source unit 20 may also include, besides the POST connector 22, at least one POST connector having the configuration similar to that of the POST connector 22. The POST connector may be configured by a computer in which the POST connector itself constitutes the information system from which the file is acquired. Note that the POST connector is also a component of the data association system 30.

The data source unit 20 includes a POST agent 23, which serves as a data collection system, for acquiring structured data from a database of the structured data that is maintained in the information system, and transmitting the acquired structured data to a pipeline, which will be described later, of the data association system 30. The data source unit 20 may also include, besides the POST agent 23, at least one POST agent having the configuration similar to that of the POST agent 23. The POST agent may be configured by a computer in which the POST agent itself constitutes the information system from which the structured data is acquired. Note that the POST agent is also a component of the data association system 30.

The data source unit 20 includes a GET-purpose agent 24, which serves as a data collection system, for generating structured data for association on the basis of the data maintained in the information system. The data source unit 20 may also include, besides the GET-purpose agent 24, at least one GET-purpose agent having the configuration similar to that of the GET-purpose agent 24. The GET-purpose agent may be configured by a computer which constitutes the information system maintaining the data from which the structured data for association is generated. Note that the GET-purpose agent is also a component of the data association system 30.

The data association system 30 includes a data storage system 40 which stores data produced by the data source unit 20, an application unit 50 which uses the data stored in the data storage system 40, and a control service unit 60 which executes various kinds of control over the data storage system 40 and the application unit 50.

The data storage system 40 includes a pipeline 41 which stores the data produced by the data source unit 20. The data storage system 40 may also include, in addition to the pipeline 41, at least one pipeline. Since the configurations of data in the information systems may differ for each information system, the data storage system 40 basically includes a pipeline for each information system. Each of the pipelines may be configured by a single computer, or may be configured by multiple computers.

The data storage system 40 includes a GET connector 42, which serves as a data collection system, for acquiring a file of structured data or unstructured data that is maintained in the information system, and associating the acquired file with the pipeline. The data storage system 40 may also include, besides the GET connector 42, at least one GET connector having the configuration similar to that of the GET connector 42. The GET connector may be configured by a computer in which the GET connector itself constitutes the pipeline with which the file is associated.

Note that in the system 10, the data source unit 20 is provided with the POST connector to be adapted to the information system which does not allow a file of structured data or unstructured data to be acquired from the data storage system 40. Meanwhile, in the system 10, the data storage system 40 is provided with the GET connector to be adapted to the information system which allows a file of structured data or unstructured data to be acquired from the data storage system 40.

The data storage system 40 includes a GET agent 43, which serves as a data collection system, for acquiring the structured data generated by the GET-purpose agent, and associating the acquired structured data with the pipeline. The data storage system 40 may also include, besides the GET agent 43, at least one GET agent having the configuration similar to that of the GET agent 43. The GET agent may be configured by a computer in which the GET agent itself constitutes the pipeline with which the structured data is associated.

Note that in the system 10, the data source unit 20 is provided with the POST agent to be adapted to the information system which does not allow structured data to be acquired from the data storage system 40. Meanwhile, in the system 10, the data source unit 20 is provided with the GET-purpose agent, and the data storage system 40 is provided with the GET agent to be adapted to the information system which allows structured data to be acquired from the data storage system 40.

The data storage system 40 includes the big-data analysis unit 44, which serves as a data conversion system, for executing final conversion processing as data conversion processing of converting the data stored by a plurality of pipelines into a form that can be counted or searched by a query language, i.e., a database language such as SQL, for example. The big-data analysis unit 44 can also execute a search or counting in response to a search request or counting request from the application unit 50 for the data on which the final conversion processing is executed. The big-data analysis unit 44 may be configured by a single computer, or may be configured by multiple computers.

The final conversion processing may include data integration processing of integrating data of a plurality of information systems as the data conversion processing. In a case where the system 10 includes, as the information systems, a remote management system disposed in Asia for remotely managing a large number of image forming apparatuses disposed in Asia, a remote management system disposed in Europe for remotely managing a large number of image forming apparatuses disposed in Europe, and a remote management system disposed in the U.S. for remotely managing a large number of image forming apparatuses disposed in the U.S., each of these three remote management systems has a device management table for management of the image forming apparatuses that the remote management system itself manages. The device management table corresponds to information indicating various kinds of information of the image forming apparatus in association with an ID assigned to each of the image forming apparatuses. Here, since each of the three remote management systems has the device management table of its own individually, it is possible that the same ID will be assigned to different image forming apparatuses among the device management tables of the three remote management systems. Therefore, when the big-data analysis unit 44 integrates the device management tables of the three remote management systems to generate a single device management table, the big-data analysis unit 44 reassigns the IDs of the image forming apparatuses so as to avoid duplication of the IDs.

The application unit 50 is provided with an application service 51 for performing a specific operation instructed by the user, for example, such as displaying data or analyzing data by using data managed by the big-data analysis unit 44. The application unit 50 may be provided with at least one application service in addition to the application service 51. Each of the application services may be configured by one computer or may be configured by a plurality of computers.

The application unit 50 includes an API platform 52 which provides an Application Programming Interface (API) that uses the data managed by the big-data analysis unit 44 and executes a specific operation. The API platform 52 may be configured by a single computer, or may be configured by multiple computers. For example, the APIs to be provided by the API platform 52 include an API which sends, to a consumable ordering system, which is a system outside the system 10, for ordering consumables when the remaining amount of a consumable such as a toner of the image forming apparatus is less than or equal to a specific amount, data on the remaining amount of the consumables collected from the image forming apparatus by means of the remote management system, and an API which sends, to a trouble prediction system, which is a system outside the system 10, for predicting a trouble of the image forming apparatus, various kinds of data collected from the image forming apparatus by means of the remote management system.

The control service unit 60 is provided with a pipeline orchestrator 61 as a processing monitoring system for monitoring processing of each stage with respect to data in the data source unit 20, the data storage system 40, and the application unit 50. The pipeline orchestrator 61 may be configured by one computer or may be configured by a plurality of computers.

The control service unit 60 includes a configuration management server 62 which saves the configuration and the settings of the data storage system 40, and automatically executes deployment as needed. The configuration management server 62 may be configured by a single computer, or may be configured by multiple computers. The configuration management server 62 constitutes a configuration change system which changes the configuration of the data association system 30.

The control service unit 60 includes a configuration management gateway 63 which connects to the configuration management server of the information system, and collects information for detecting a change in the configuration related to the database or unstructured data in the information system, in other words, a change in the configuration of data in the information system. The configuration management gateway 63 may be configured by a single computer, or may be configured by multiple computers.

The control service unit 60 includes a key management service 64 which encrypts and stores security information, such as key information and connect strings, necessary for achieving association between the respective systems such as the information systems. The key management service 64 may be configured by a single computer, or may be configured by multiple computers.

The control service unit 60 includes a management API 65 which accepts requests from the data storage system 40 and the application unit 50. The management API 65 may be configured by a single computer, or may be configured by multiple computers.

The control service unit 60 is provided with an authentication and authorization service 66 for performing an application service of the application unit 50, and authentication and authorization of the API platform 52. The authentication and authorization service 66 may be configured by one computer or may be configured by a plurality of computers. The authentication and authorization service 66 can confirm, for example, whether an application service is permitted to request updating data of the information system, which are stored in the data storage system 40.

The control service unit 60 is provided with an authentication proxy 67 as an authentication control system for controlling authentication of a user. The authentication proxy 67 may be configured by one computer or may be configured by a plurality of computers.

Next, an operation of the system 10 is described.

First, an operation of the system 10 when the user logs in to the data association system 30 is described.

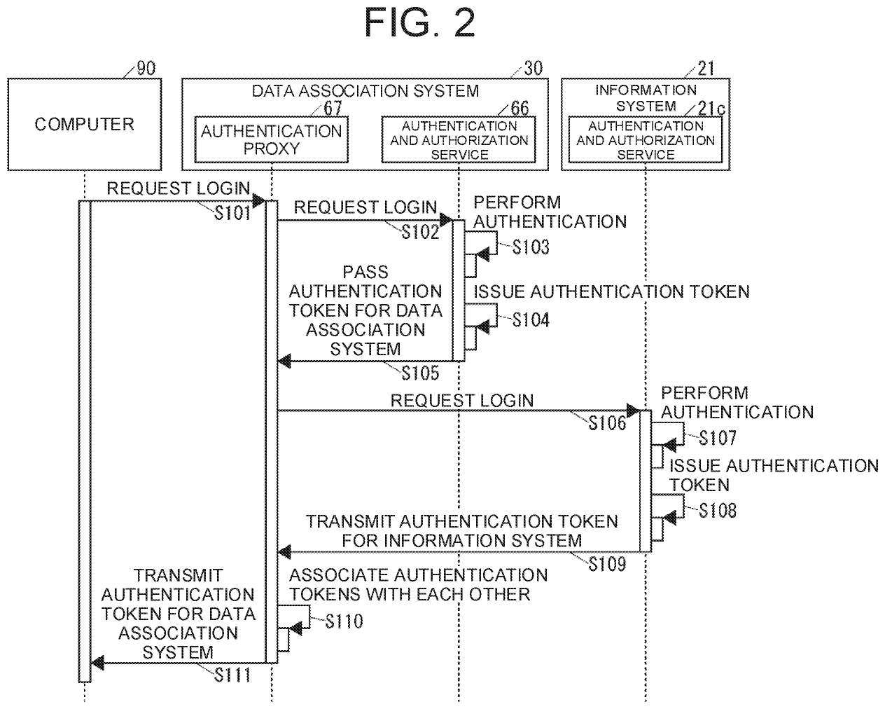

FIG. 2 is a sequence diagram of the operation of the system 10 when the user logs in to the data association system 30.

As shown in FIG. 2, the user requests the authentication proxy 67 of the data association system 30 to log in by using the computer 90 (S101). The computer 90 includes, in the request in S101, authentication information for causing the data association system 30 to authenticate the user. The authentication information included in the request in S101 is, for example, information being a combination of an ID and a password. The authentication information included in the request in S101 is, for example, information input to the computer 90 by the user.

When the login is requested in S101, the authentication proxy 67 requests the authentication and authorization service 66 to log in to the data association system 30 by the user (S102). The authentication proxy 67 includes, in the request in S102, the authentication information included in the request in S101.

When the login is requested in S102, the authentication and authorization service 66 performs authentication, based on the authentication information included in the request in S102 (S103). When the authentication is successful, the authentication and authorization service 66 issues an authentication token for the data association system 30 (S104).

When the authentication and authorization service 66 issues the authentication token in S104, the authentication and authorization service 66 passes, to the authentication proxy 67, the authentication token for the data association system 30, which is issued in S104 (S105).

After the processing in S105, the authentication proxy 67 requests the authentication and authorization service 21c of the information system 21 to log in to the information system 21 (S106). The authentication proxy 67 includes, in the request in S106, authentication information for causing the information system 21 to authenticate the authentication proxy 67. Herein, logging in the information system 21 as well as the data association system 30 when the user logs in to the data association system 30, and authentication information for causing the information system 21 to authenticate the authentication proxy 67 are set in the authentication proxy 67. The authentication information included in the request in S106 may be any information indicating that the request is a login request from the data association system 30. For example, the authentication information included in the request in S106 may be information being a combination of a specific ID and a specific password, information indicating a specific user, or a specific electronic certificate.

When the login is requested in S106, the authentication and authorization service 21c performs authentication, based on the authentication information included in the request in S106 (S107). When the authentication is successful, the authentication and authorization service 21c issues an authentication token for the information system 21 (S108).

When the authentication and authorization service 21c issues the authentication token in S108, the authentication and authorization service 21c transmits, to the authentication proxy 67, the authentication token for the information system 21, which is issued in S108 (S109).

After the processing in S109, the authentication proxy 67 associates the authentication token for the data association system 30, which is passed from the authentication and authorization service 66 in S105, with the authentication token for the information system 21, which is transmitted from the authentication and authorization service 21c in S109 (S110).

After the processing in S110, the authentication proxy 67 transmits, to the computer 90, the authentication token for the data association system 30, which is passed from the authentication and authorization service 66 in S105 (S111).

In the operation shown in FIG. 2, the system 10 is configured to log in to the information system 21, when the user logs in to the data association system 30. However, when the user logs in to the data association system 30, the system 10 may not log in to the information system 21, but log in to an information system other than the information system 21. In addition, the system 10 may log in to a plurality of information systems, when the user logs in to the data association system 30.

Next, an operation of the system 10 when the user uses the application service 51 of the data association system 30 is described.

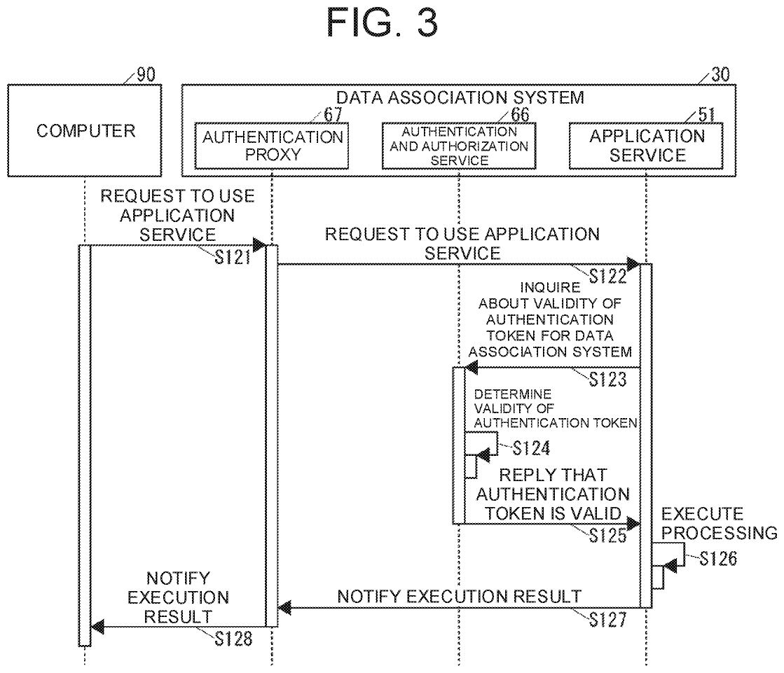

FIG. 3 is a sequence diagram of the operation of the system 10 when the user uses the application service 51 of the data association system 30.

As shown in FIG. 3, the user requests the authentication proxy 67 of the data association system 30 to use the application service 51 of the data association system 30 by using the computer 90 (S121). The computer 90 includes, in the request in S121, the authentication token for the data association system 30, which is transmitted from the data association system 30 in S111.

When the authentication proxy 67 is requested to use the application service 51 in S121, the authentication proxy 67 requests the application service 51 to use the application service 51 (S122). The authentication proxy 67 includes, in the request in S122, the authentication token for the data association system 30, which is included in the request in S121.

When the application service 51 is requested to use the application service 51 in S122, the application service 51 makes an inquiry to the authentication and authorization service 66 about the validity of the authentication token for the data association system 30, which is included in the request in S122 (S123).

When the validity of the authentication token for the data association system 30 is inquired in S123, the authentication and authorization service 66 determines the validity of the authentication token (S124).

When the authentication and authorization service 66 determines in S124 that the authentication token is valid, the authentication and authorization service 66 replies to the application service 51 that the authentication token is valid (S125).

When the application service 51 is replied in S125 that the authentication token is valid, the application service 51 executes the processing of the content requested in S121 (S126). Herein, the application service 51 can execute the processing within the range of the authorization authority, which is determined in S124 by the authentication and authorization service 66 for the account associated with the authentication token.

After the processing in S126, the application service 51 notifies the authentication proxy 67 of the execution result in S126 (S127).

When the authentication proxy 67 receives the notification in S127, the authentication proxy 67 notifies the computer 90 of the execution result notified in S127 (S128).

Note that the system 10 is configured such that the user uses the application service 51 in the operation shown in FIG. 3. However, the system 10 is also operated in a similar manner, when the user uses an application service of the data association system 30 other than the application service 51, or when the user uses the API platform 52 of the data association system 30.

Next, an operation of the system 10 when the user uses the information system 21 is described.

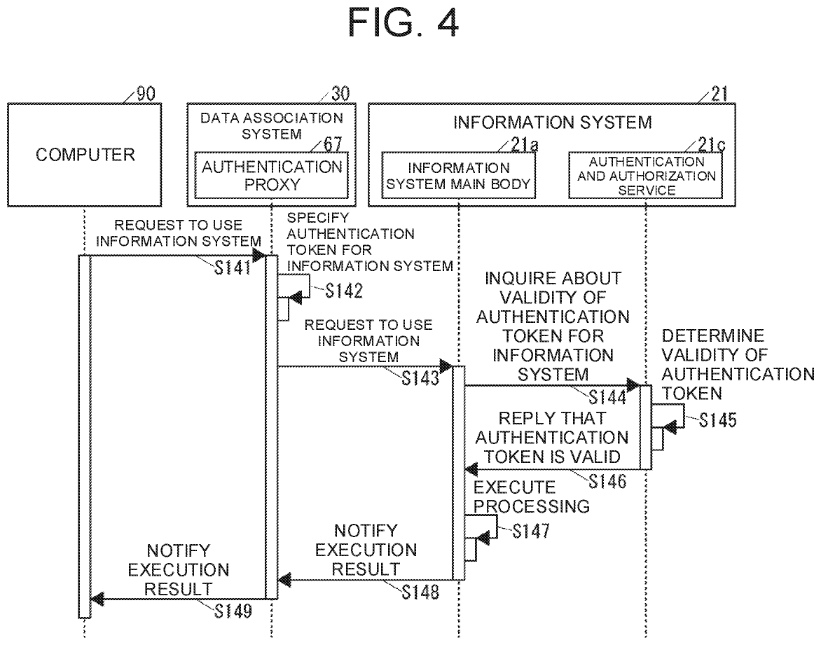

FIG. 4 is a sequence diagram of the operation of the system 10 when the user uses the information system 21.

As shown in FIG. 4, the user requests the authentication proxy 67 of the data association system 30 to use the information system 21 by using the computer 90 (S141). The computer 90 includes, in the request in S141, the authentication token for the data association system 30, which is transmitted from the data association system 30 in S111. The request in S141 may be made, for example, by specifying specific information indicating the information system 21 in a uniform resource locator (URL), as exemplified by “authentication proxy 67/information system 21”. The URL in which specific information indicating the information system 21 is specified may be embedded, for example, in a Web UI of the data association system 30 in such a way that the URL is shifted to a Web screen of the information system 21, when the Web UI on a Web screen of the data association system 30 is operated.

When the authentication proxy 67 is requested to use the information system 21 in S141, the authentication proxy 67 specifies the authentication token for the information system 21, which is included in the request in S141, and which is associated with the authentication token for the data association system 30 in S110 (S142).

Next, the authentication proxy 67 requests the information system main body 21a to use the information system 21 (S143). The authentication proxy 67 includes, in the request in S143, the authentication token for the information system 21, which is specified in S142.

When the information system main body 21a is requested to use the information system 21 in S143, the information system main body 21a makes an inquiry to the authentication and authorization service 21c about the validity of the authentication token for the information system 21, which is included in the request in S143 (S144).

When the validity of the authentication token for the information system 21 has been inquired in S144, the authentication and authorization service 21c determines the validity of the authentication token (S145).

When the authentication and authorization service 21c determines in S145 that the authentication token is valid, the authentication and authorization service 21c replies to the information system main body 21a that the authentication token is valid (S146).

When the information system main body 21a is replied in S146 that the authentication token is valid, the information system main body 21a executes the processing of the content requested in S141 (S147). Herein, the information system main body 21a can execute the processing within the range of the authorization authority, which is determined for the account associated with the authentication token by the authentication and authorization service 21c in S145.

After the processing in S147, the information system main body 21a notifies the authentication proxy 67 of the execution result in S147 (S148).

Upon receiving the notification in S148, the authentication proxy 67 notifies the computer 90 of the execution result notified in S148 (S149).

As described above, when the data association system 30 issues an authentication token for the data association system 30 (S104), the data association system 30 acquires, from the information system 21, an authentication token for the information system 21 by using specific authentication information (S106 to S109). When use of the data association system 30 is requested of the data association system 30 by using the authentication token for the data association system 30 (S121), the data association system 30 causes the data association system 30 to use the data association system 30 itself (S126). When the data association system 30 is requested to use the information system 21 by using the authentication token for the data association system 30 (S141), the data association system 30 makes a request to the information system 21 for use of the information system 21 by using the authentication token for the information system 21, which is acquired when the authentication token for the data association system 30 is issued (S142 to S143). Therefore, it is possible to differentiate the authentication method in the information system 21, and the authentication method in the data association system 30 itself from each other, when a single sign-on is achieved with respect to the information system 21.

### Second Embodiment

First, a configuration of a system according to a second embodiment of the present disclosure is described.

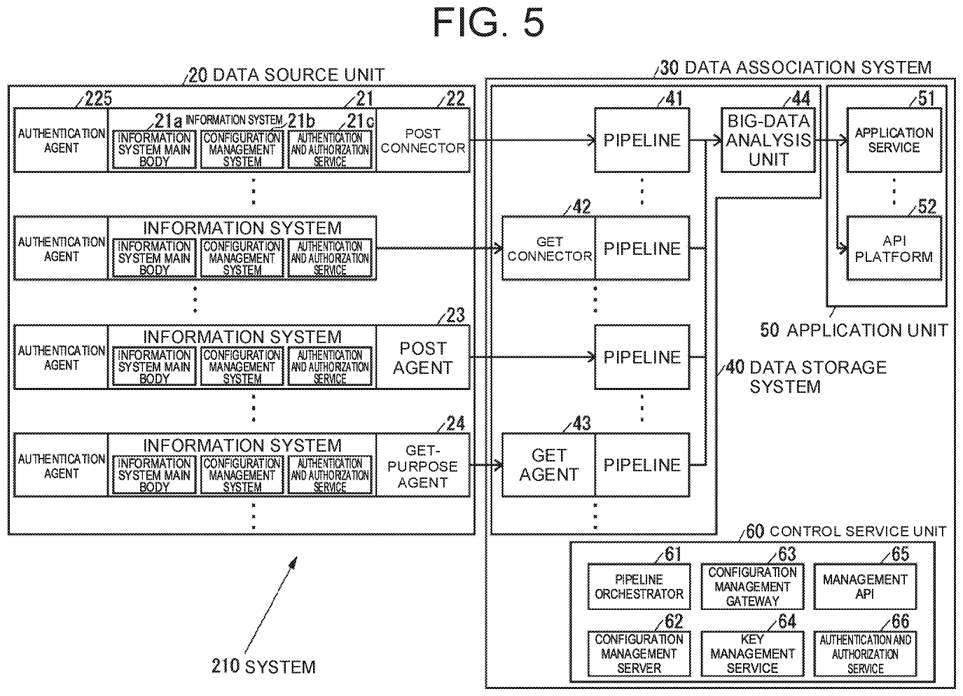

FIG. 5 is a block diagram of a system 210 according to the present embodiment.

A configuration of the system 210 shown in FIG. 5 is similar to the configuration of the system 10 (see FIG. 1) according to the first embodiment, except for the configuration to be described below. Among the constituent elements of the system 210, constituent elements similar to the constituent elements of the system 10 are designated by the same reference numerals as the constituent elements of the system 10, and detailed description thereof is omitted.

As shown in FIG. 5, the configuration of the system 210 is similar to the configuration of the system 10 in that the authentication proxy 67 (see FIG. 1) is not provided but an authentication agent to be described later is provided.

As shown in FIG. 5, a data source unit 20 may be provided with an authentication agent 225 for an information system 21, as an authentication control system for controlling authentication of a user. The data source unit 20 may be provided with an authentication agent for each information system, in addition to the authentication agent 225. Each of the authentication agents may be configured by one computer or may be configured by a plurality of computers.

Next, an operation of the system 210 is described.

First, an operation of the system 210 when the user logs in to the information system 21 is described.

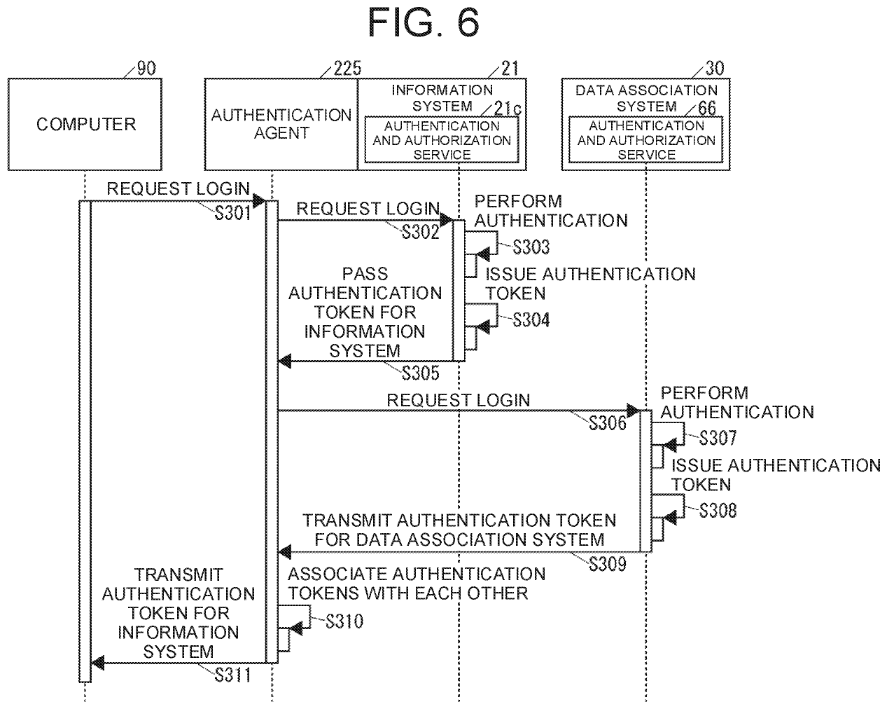

FIG. 6 is a sequence diagram of the operation of the system 210 when the user logs in to the information system 21.

As shown in FIG. 6, the user makes a request to the authentication agent 225 of the information system 21 in order to log in by using a computer 90 (S301). The computer 90 includes, in the request in S301, authentication information for causing the information system 21 to authenticate the user. The authentication information included in the request in S301 is, for example, information being a combination of an ID and a password. The authentication information included in the request in S301 is, for example, information input to the computer 90 by the user.

When the login is requested in S301, the authentication agent 225 requests an authentication and authorization service 21c of the information system 21 to log in to the information system 21 by the user (S302). The authentication agent 225 includes, in the request in S302, the authentication information included in the request in S301.

When the login is requested in S302, the authentication and authorization service 21c performs authentication, based on the authentication information included in the request in S302 (S303). When the authentication is successful, the authentication and authorization service 21c issues an authentication token for the information system 21 (S304).

When the authentication and authorization service 21c issues the authentication token in S304, the authentication and authorization service 21c passes, to the authentication agent 225, the authentication token for the information system 21, which is issued in S304 (S305).

After the processing in S305, the authentication agent 225 makes a request to authentication and authorization service 66 of a data association system 30 in order to log in to the data association system 30 (S306). The authentication agent 225 includes, in the request in S306, the authentication information for causing the data association system 30 to authenticate the authentication agent 225. Herein, logging in the data association system 30 as well as the information system 21 when the user logs in to the information system 21, and authentication information for causing the data association system 30 to authenticate the authentication agent 225 are set in the authentication agent 225. The authentication information included in the request in S306 may be any information indicating that the request is a login request from the information system 21. For example, the authentication information included in the request in S306 may be information being a combination of a specific ID and a specific password, information indicating a specific user, or a specific electronic certificate.

When the login is requested in S306, the authentication and authorization service 66 performs authentication, based on the authentication information included in the request in S306 (S307). When the authentication is successful, the authentication and authorization service 66 issues an authentication token for the data association system 30 (S308).

When the authentication and authorization service 66 issues the authentication token in S308, the authentication and authorization service 66 transmits, to the authentication agent 225, the authentication token for the data association system 30, which is issued in S308 (S309).

After the processing in S309, the authentication agent 225 associates the authentication token for the information system 21, which is passed from the authentication and authorization service 21c in S305, with the authentication token for the data association system 30, which is transmitted from the authentication and authorization service 66 in S309 (S310).

After the processing in S310, the authentication agent 225 transmits, to the computer 90, the authentication token for the information system 21, which is passed from the authentication and authorization service 21c in S305 (S311).

In the operation shown in FIG. 6, the system 210 is configured to log in to the data association system 30 when the user logs in to the information system 21. However, the system 210 may be configured to also log in to the data association system 30, when the user logs in to an information system other than the information system 21.

Next, an operation of the system 210 when the user uses the information system 21 is described.

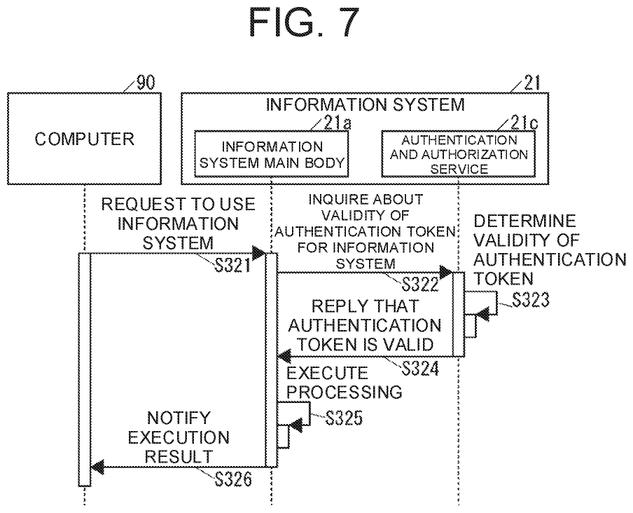

FIG. 7 is a sequence diagram of the operation of the system 210 when the user uses the information system 21.

As shown in FIG. 7, the user makes a request to an information system main body 21a for use of the information system 21 by using the computer 90 (S321). The computer 90 includes, in the request in S321, the authentication token for the information system 21, which is transmitted from the information system 21 in S311.

When use of the information system 21 is requested of the information system main body 21a in S321, the information system main body 21a makes an inquiry to the authentication and authorization service 21c about the validity of the authentication token for the information system 21, which is included in the request in S321 (S322).

When the validity of the authentication token for the information system 21 has been inquired in S322, the authentication and authorization service 21c determines the validity of the authentication token, which is included in the inquiry in S322 (S323).

When the authentication and authorization service 21c determines in S323 that the authentication token is valid, the authentication and authorization service 21c replies to the information system main body 21a that the authentication token is valid (S324).

When the information system main body 21a is replied in S324 that the authentication token is valid, the information system main body 21a executes the processing of the content requested in S321 (S325). Herein, the information system main body 21a can execute the processing within the range of the authorization authority, which is determined for the account associated with the authentication token by the authentication and authorization service 21c in S323.

After the processing in S325, the information system main body 21a notifies the computer 90 of the execution result in S325 (S326).

Next, an operation of the system 210 when the user uses an API platform 52 of the data association system 30 is described.

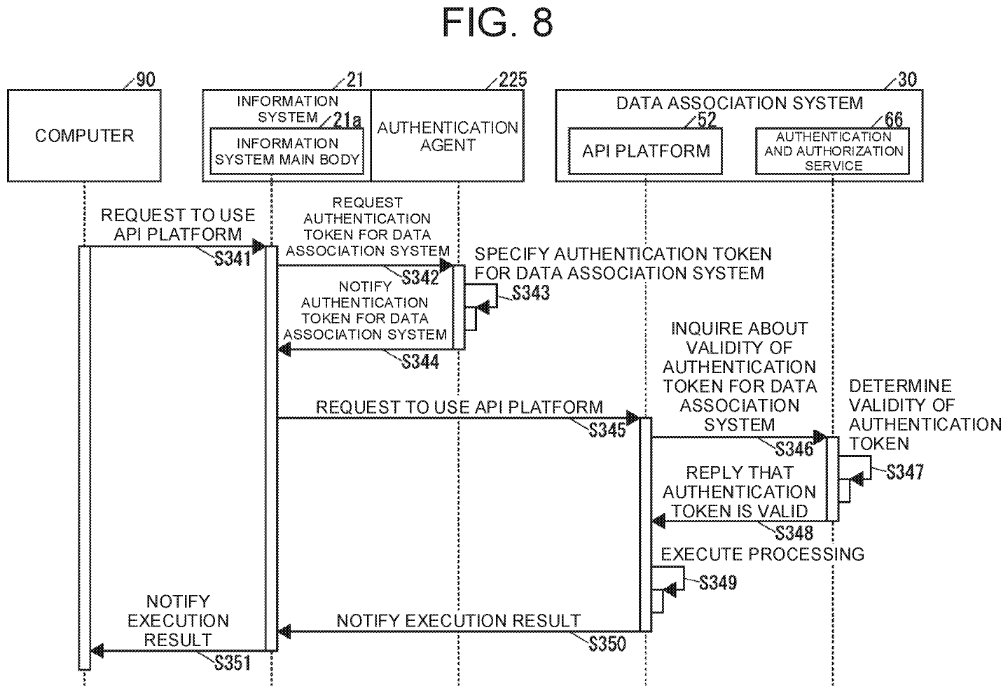

FIG. 8 is a sequence diagram of the operation of the system 210 when the user uses the API platform 52 of the data association system 30.

As shown in FIG. 8, the user makes a request to the information system main body 21a for use of the API platform 52 of the data association system 30 by using the computer 90 (S341). The computer 90 includes, in the request in S341, the authentication token for the information system 21, which is transmitted from the information system 21 in S311. The request in S341 may be made, for example, by specifying specific information indicating the API platform 52 in a URL, as exemplified by “/informationsystem21/APIplatform52”. The URL in which specific information indicating the API platform 52 is specified may be embedded, for example, in a Web UI of the information system 21 in such a way that the URL is shifted to a Web screen of the API platform 52, when the Web UI on a Web screen of the information system 21 is operated.

When use of the API platform 52 is requested by the information system main body 21a in S341, the information system main body 21a requests the authentication token for the data association system 30 from the authentication agent 225 (S342). The information system main body 21a includes, in the request in S342, the authentication token for the information system 21, which is included in the request in S341.

When the authentication token for the data association system 30 is requested in S342, the authentication agent 225 specifies the authentication token for the data association system 30, which is included in the request in S342, and which is associated with the authentication token for the information system 21 in S310 (S343).

Next, the authentication agent 225 notifies the information system main body 21a of the authentication token for the data association system 30, which is specified in S343 (S344).

When the authentication token for the data association system 30 is notified in S344, the information system main body 21a makes a request to the API platform 52 for use of the API platform 52 (S345). The information system main body 21a includes, in the request in S345, the authentication token for the data association system 30, which is notified in S344.

When to use of the API platform 52 is requested of the API platform 52 in S345, the API platform 52 makes an inquiry to the authentication and authorization service 66 about the validity of the authentication token for the data association system 30, which is included in the request in S345 (S346).

When the validity of the authentication token for the data association system 30 is inquired in S346, the authentication and authorization service 66 determines the validity of the token (S347).

When the authentication and authorization service 66 determines in S347 that the authentication token is valid, the authentication and authorization service 66 replies to the API platform 52 that the authentication token is valid (S348).

When the API platform 52 is replied in S348 that the authentication token is valid, the API platform 52 executes the processing of the content requested in S345 (S349). Herein, the API platform 52 can execute the processing within the range of the authorization authority, which is determined for the account associated with the authentication token by the authentication and authorization service 66 in S347.

After the processing in S349, the API platform 52 notifies the information system main body 21a of the execution result in S349 (S350).

Upon receiving the notification in S350, the information system main body 21a notifies the computer 90 of the execution result notified in S350 (S351).

Note that the operation shown in FIG. 8 is an operation when the user uses the API platform 52 of the data association system 30. However, an operation when the user uses an application service of the data association system 30 is similar to the above.

As described above, the system 210 is configured such that when the information system 21 issues an authentication token for the information system 21 (S304), the authentication agent 225 acquires, from the data association system 30, an authentication token for the data association system 30 by using specific authentication information (S306 to S309), when the information system 21 is requested to use the information system 21 by using the authentication token for the information system 21 (S321), the information system 21 causes the information system 21 to use the information system 21 itself (S325), and when the information system 21 is requested to use the data association system 30 by using the authentication token for the information system 21 (S341), the information system 21 requests the data association system 30 to use the data association system 30 by using the authentication token for the data association system 30, which is acquired when the authentication token for the information system 21 is issued (S345). Therefore, it is possible to differentiate the authentication method in the information system 21 and the authentication method in the data association system 30 from each other, when a single sign-on is achieved between the information system 21, and the data association system 30 that collects and stores data maintained by the information system 21.

What is claimed is:

1. An authentication control system for controlling authentication of a user in a data association system that collects and stores data maintained by an information system, wherein
the data association system issues an authentication token for the data association system by authentication of a user, and
the authentication control system acquires, from the information system, an authentication token for the information system by using specific authentication information when the data association system issues an authentication token for the data association system.

2. A data association system that collects and stores data maintained by an information system, comprising an authentication control system for controlling authentication of a user, wherein
the data association system issues an authentication token for the data association system by authentication of a user,
the authentication control system acquires, from the information system, an authentication token for the information system by using specific authentication information when the data association system issues an authentication token for the data association system,
the data association system causes use of the data association system when use of the data association system is requested by using an authentication token for the data association system, and
the data association system makes a request to the information system for use of the information system by using an authentication token for the information system, which is acquired when an authentication token for the data association system is issued, when use of the information system is requested, by using the authentication token for the data association system.

3. An authentication control system for controlling authentication of a user in a system provided with an information system, and a data association system that collects and stores data maintained by the information system, wherein
the information system issues an authentication token for the information system by authentication of a user, and
the authentication control system acquires, from the data association system, an authentication token for the data association system by using specific authentication information when the information system issues an authentication token for the information system.

4. A system comprising:
an information system; and
a data association system that collects and stores data maintained by the information system, wherein
the system comprises an authentication control system for controlling authentication of a user,
the information system issues an authentication token for the information system by authentication of a user,
the authentication control system acquires, from the data association system, an authentication token for the data association system by using specific authentication information when the information system issues an authentication token for the information system,
the information system causes the information system to use the information system, when the information system is requested to use the information system by using an authentication token for the information system, and
the information system makes a request to the data association system for use of the data association system by using an authentication token for the data association system, which is acquired when an authentication token for the information system is issued, when use of the data association system is requested, by using the authentication token for the information system.
